(19) United States
(12) Patent Application Publication
(10) Pub. No.: US 2011/0032335 A1
(43) Pub. Date: Feb. 10, 2011

(54) VIDEO STEREOMICROSCOPE

(75) Inventor: Ulrich SANDER, Rebstein (CH)

Correspondence Address: HODGSON RUSS LLP;THE GUARANTY BUILDING, 140 PEARL STREET, SUITE 100, BUFFALO, NY, 14202-4040, US

(73) Assignee: LEICA MICROSYSTEMS (SCHWEIZ) AG, Heerbrugg (CH)

(21) Appl. No.: 12/848,554

(22) Filed: Aug. 2, 2010

(30) Foreign Application Priority Data
Aug. 7, 2009 (DE) 10 2009 028 355.2
Apr. 1, 2010 (DE) 10 2010 003 640.4

(51) Int. Cl. H04N 13/02; G02B 21/22; G02B 21/36

(52) U.S. Cl. 348/46; 359/377; 348/E13.074; 348/E13.075

(57) ABSTRACT

A video stereomicroscope includes a main objective (2) having a substantially vertical optical axis (11), a deflecting element (5) provided downstream of the objective (2) to cause light passing through the main objective (2) to be deflected into a substantially horizontal direction, and further includes a zoom system (7) which is disposed downstream of the deflecting element (5) and has at least two substantially horizontally extending observation channels (7c, 7d), a first observation channel (7c) and a second observation channel (7d) of the zoom system (7) being vertically spaced from each other. The video stereomicroscope has at least one optoelectronic image-capturing device (40a-40e) provided downstream of the zoom system (7) for providing a stereoscopic image based on beams of radiation (20c, 20d) passing through the first observation channel (7c) and the second observation channel (7d).

### CROSS REFERENCE TO RELATED APPLICATIONS

This application claims priority of the German patent application number 10 2009 028 355.2 filed Aug. 7, 2009, the entire disclosure of which is incorporated by reference herein. This application also claims priority of the German patent application number 10 2010 003 640.4 filed Apr. 1, 2010, the entire disclosure of which is incorporated by reference herein

### FIELD OF THE INVENTION

The present invention relates to a video stereomicroscope, and to a method for stereoscopic viewing using a video stereomicroscope.

### BACKGROUND OF THE INVENTION

Surgical microscopes having video outputs to which, for example, video cameras may be connected are known and are frequently referred to as “video microscopes” or “video stereomicroscopes”.

In the development of surgical microscopes, efforts have increasingly been made to find a way to present vertically and laterally correct stereoscopic (i.e. 3D) images simultaneously to several observers (e.g., main operator and assistant) at different locations.

From U.S. Pat. No. 5,867,210, it is known to provide a surgical microscope with a camera, and to transfer the captured image to a monitor. Such monitors may be mounted to mounting fixtures. However, especially in operating rooms, such mounting fixtures cannot be positioned at any desired spatial location, because this would restrict the range of motion for the operator.

German Patent DE 43 21 934 C2 describes a surgical microscope equipped with a camera that sends its images to a display device having a stereoscopic eyepiece.

U.S. Pat. No. 5,067,804 discloses a stereomicroscope that produces images of a viewed field by means of cameras, data lines, and display devices.

Many operations are performed jointly by a main operator and at least one assistant. During the procedure, the main operator and the assistant stand around an operating table. The position of the main operator is referred to as the 0-degree position. A position of an assistant standing opposite is referred to as the 180-degree position. The positions in which a further assistant may stand perpendicular to the main operator and the aforementioned assistant are referred to as 90-degree positions.

In order to facilitate the work of operators who use a video stereomicroscope while standing around the operating field at angles of 90 degrees and/or 180 degrees from each other and looking at the operating field from respective different angles, operators should be able to see on their respective display devices different stereoscopic images of an observed object according to their actual viewing perspectives. Such different stereoscopic images for the 0-degree position and the 90-degree position, for example, cannot be generated by a single stereo camera (during 3D video transmission).

European Patent Application EP 1 887 403 A1 overcomes this difficulty by separating the beam paths for an assistant at a position below an optical system including a main objective for a main operator (i.e., at a position between the object and the objective). However, since the respective decoupling device is located between the object and the main objective of the main operator, the free working space is restricted, which can make it difficult for the operator to introduce very long instruments into the operating field, or to move such instruments as desired within the operating field.

### SUMMARY OF THE INVENTION

It is an object of the present invention to enable vertically and laterally correct stereoscopic (i.e. 3D) images to be presented at different positions during video display, in particular at the 0-degree, 90-degree and 180-degree positions of a surgical microscope, without restricting the free working space.

This object is achieved by a video stereomicroscope or surgical microscope having the features of claim 1 and a method having the features of claim 11.

The present invention makes use of the characteristics of a substantially horizontally oriented zoom or pancratic system having at least two, in particular four, observation channels. The use of a horizontally oriented zoom system, first of all, allows the stereomicroscope of the present invention to be made very flat. The small height that can be achieved in this manner is particularly advantageous in surgical microscopes for ergonomic reasons. The at least two, in particular four, observation channels very advantageously allow an object to be viewed by a main operator or by a main operator and an assistant. Since there is no separation of beam paths below the main objective, the free working space below the main objective can be retained in its entirety. This is also beneficial especially when other components have to be provided upstream of the main objective; i.e., between the object and the main objective. In this connection, particular reference is made to inverter systems, known as BIOM and SDI systems.

Advantageous embodiments of the video stereomicroscope of the present invention are the subject matter of the dependent claims.

Advantageously, the image-capturing device provides a stereoscopic image having a vertical stereo basis, a display device being provided to display this image with a horizontal stereo basis; i.e., rotated 90 degrees about a horizontal axis. Expediently, the display device is disposed in a viewing position 90 degrees offset from the optoelectronic image-capturing device. This offsetting corresponds to a rotation of, for example, 90 degrees about a vertical axis. The image-capturing device may be located, for example, in the 180-degree viewing position (where it hinders the surgeon only minimally), while the display device is disposed in a 90-degree viewing position.

Advantageously, the image-capturing device takes the form of a two-channel stereo camera. Using a stereo camera of this type, a stereoscopic image can be produced based on the two parallel-extending observation beams, and be displayed on a suitable display device (monitor).

The image-capturing device, in particular the stereo camera, preferably has one imaging optical system and one camera chip for each observation channel, or one imaging optical system and one camera chip for two observation channels, as well as suitable electronics for image processing. Via such electronics for image processing and control, electronically generated 3D or stereoscopic images can thus be displayed to the operator via a display and/or viewing device, such as 3D monitors or 3D glasses or 3D eyepieces. In this context, “3D eyepieces” are understood to mean, in particular, a viewing unit (tube) including two displays and two oculars, each of which is associated with one of the displays, respectively. When the stereo camera is suitably positioned, the captured images are stereoscopically correct.

Expediently, the transmission of data between the image-capturing device and the display device is via cable or wireless. Preferably, the stereo camera may be used at the same time as a camera for recording three-dimensional or two-dimensional image data.

In order to obtain stereoscopically correct images, it may be necessary to increase the number of deflections using image-inverting prisms.

Preferably, the zoom system of the video stereomicroscope of the present invention has a third and a fourth observation channel, said third and fourth observation channels extending through the zoom system at the same horizontal level.

In an especially preferred embodiment, the video stereomicroscope of the present invention has an additional image-capturing device for providing an image based on beams of radiation passing through the third and fourth observation channels, and an additional display device for displaying the additional image so produced without rotation (about a horizontal axis of rotation). In accordance with this preferred embodiment, a main operator and an assistant can stand at the operating table at an angle of, for example, 90 degrees from each other (in the 0-degree and 90-degree positions), while the image-capturing devices used for the main operator and the assistant are positioned on substantially opposite sides of the operating table (0-degree and 180-degree positions). In other words, if the position of the main operator, and of the image-capturing device assigned to him or her, is the 0-degree position, then the image-capturing device for the assistant is in the 180-degree position. This means that, unlike in previous approaches, the stereo camera for the 90-degree position does not need to be actually mechanically/optically mounted at 90 degrees to the microscope, but advantageously at 180 degrees with respect thereto, as described above. In this manner, this camera is maximally spaced from the main operator. This arrangement hinders the work of both the surgeon and the assistant only minimally.

In an especially preferred embodiment of the video stereomicroscope according to the present invention, at least two observation channels of the zoom system, particularly the vertically spaced first and second observation channels, are rotatable relative to the direction of longitudinal extension of the zoom system. As a result of such a rotation, the first and second observation channels are no longer in exact vertical alignment above each other, but slightly oblique i.e. extend parallel to each other in a plane that is oblique to the vertical. Thus, the stereo basis defined by the first and second observation channels also extends obliquely with respect to the vertical.

This rotation of the first and second observation channels may expediently be effected automatically, for example, when the assistant moves his display device a few degrees from an initial 90-degree viewing position toward the 180-degree position, for example, to get out of the way of the main surgeon. The displacement of the observer with respect to the 90-degree position is preferably detected by sensors provided on the display device, and is transferred to a processing and evaluation unit associated with the zoom system.

### BRIEF DESCRIPTION OF THE DRAWING VIEWS

The present invention will now be described further with reference to the accompanying drawing, in which:

FIG. 1 is schematic side view showing the overall design of a preferred embodiment of the video stereomicroscope according to the present invention;

FIG. 2 is a cross-sectional view of a preferred embodiment of a zoom or pancratic system that can be used in accordance with the present invention;

FIG. 3 is an elevation view of a preferred embodiment of a deflecting element that can be used in accordance with the present invention to partly deflect beams of radiation;

FIG. 4 is an enlarged view of deflecting elements that can be used in the video stereomicroscope of the present invention to separate the main beam path and the assistant's beam path; and

FIG. 5 is a schematic top view of the video stereomicroscope shown in FIG. 1.

### DETAILED DESCRIPTION OF THE INVENTION

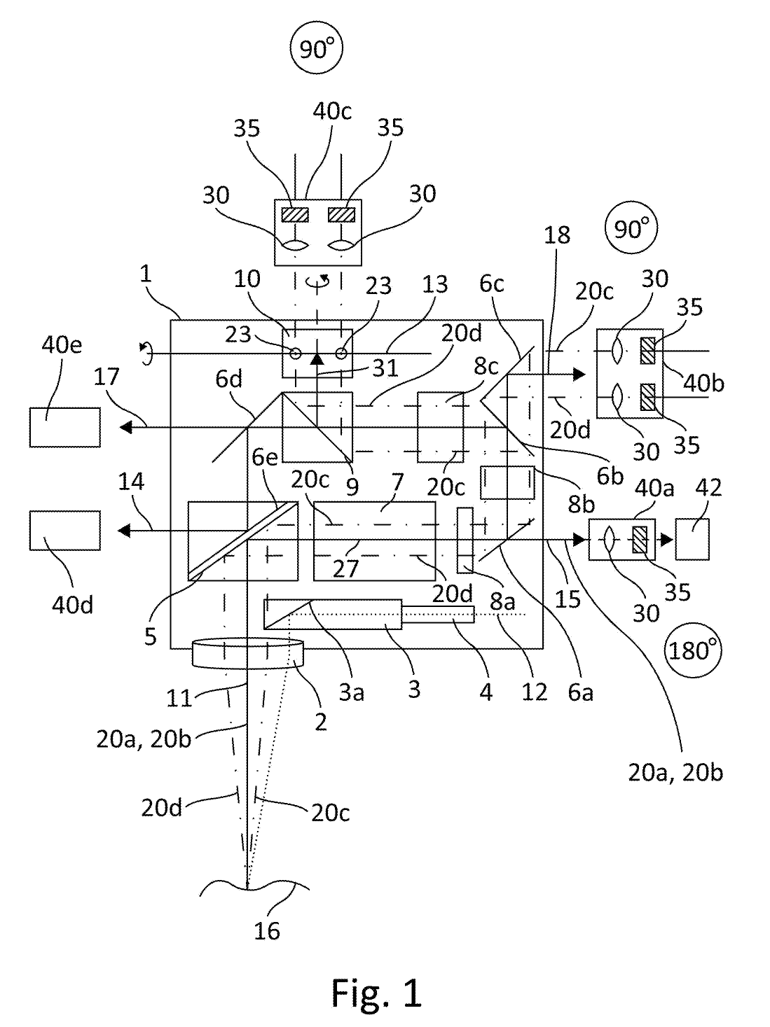

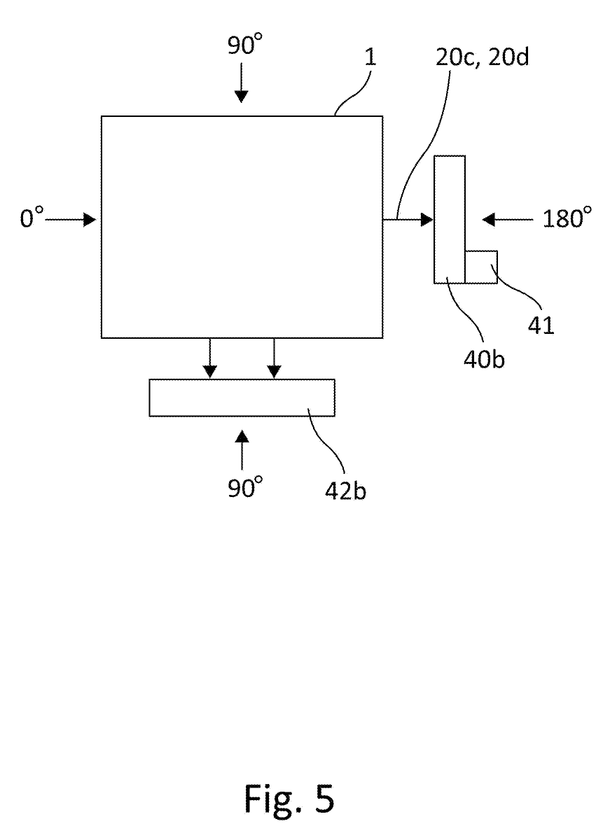

In FIGS. 1 and 5, a (schematically shown) microscope body in accordance with a preferred embodiment of the stereomicroscope of the present invention is denoted by 1. For the definition of the directions as used in this description, it is assumed that the left edge in FIG. 1 is the front (which corresponds to the 0-degree or viewing position) and the right edge is the rear of the microscope (which corresponds to the 180-degree position). The side facing the observer will be referred to as the right side, while the side facing away from the observer will be referred to as the left side of the microscope. The right and left sides of the microscope correspond to two 90-degree positions. The stereomicroscope shown is, in particular, an opthalmological microscope and is used for observing an object 16. The 0-degree, 90-degree and 180-degree positions are explicitly shown in FIG. 5.

As essential optical components, the stereomicroscope has a main objective 2, a zoom system 7, and an eyepiece system. Moreover, optoelectronic image-capturing devices in the form of stereocameras 40a, 40b, 40c, 40d, 40e are provided at various outcoupling points, and display devices in the form of monitors 42a, 42b are associated therewith, as will be explained in detail below.

A first deflecting element 5 is provided between main objective 2 and zoom system 7 (i.e., according to the terminology used herein, downstream of the main objective and upstream of the zoom system). Behind zoom system 7, additional deflecting elements 6a, 6b, 6c, 6d, 6e, 9, 10, as well as optical additional components 8, 8a are provided, the function of which will be described further below.

Reference numeral 3 denotes an illumination device which directs light delivered by a fiber cable 4 via a deflecting element 3a onto object 16 to be observed. The main axis of illumination device 3 is denoted by 12.

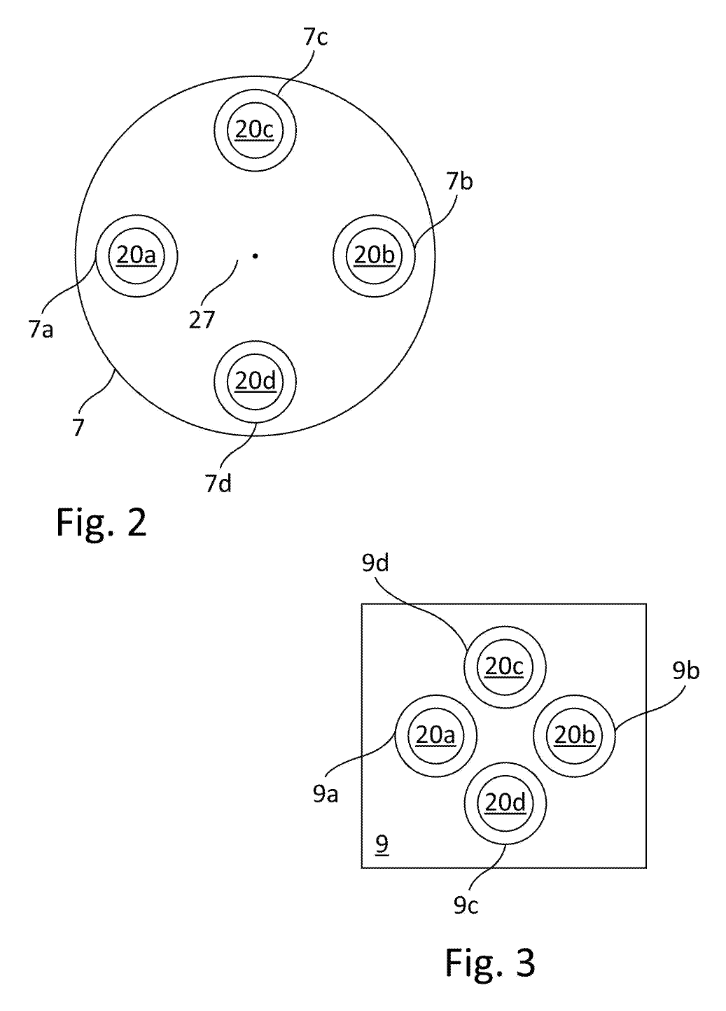

As is apparent from FIG. 2, zoom system 7 has two assistant's observation channels; i.e., first and second channels 7c, 7d, and two main operator's observation channels; i.e., third and fourth channels 7a, 7b.

Main objective 2 is traversed in a substantially vertical direction by two assistant's observation beams 20c, 20d and two main observation beams 20a, 20b, which, after being suitably (perpendicularly) deflected by deflecting element 5, enter into the substantially horizontally extending main and assistant's observation channels 7a, 7b, 7c, 7d of the zoom system. The corresponding cross sections of beams 20a-20d are shown in FIG. 2.

The two main observation beams 20a, 20b are located behind each other as viewed in a direction looking at FIG. 1, so that only one of these beams can be seen. As is also apparent from FIGS. 1 and 2, the four main and assistant's observation beams 20a through 20d are symmetrically distributed around optical axis 11 of main objective 2. Advantageously, the common axis of observation beams 20a through 20d may also pass off-center through the main objective. This applies similarly to central axis 27 of zoom system 7 (shown in FIG. 2), around which are symmetrically arranged observation channels 7a through 7d and the beams 20a through 20d passing therethrough.

It can be seen that the main operator's observation channels 7a, 7b extend in a horizontal plane; i.e., at the same level as central axis 27, while the assistant's observation channels 7c, 7d extend above and below central axis 27 at a vertical distance from each other (which corresponds to a vertical stereo basis during passage through the zoom system). The configuration shown allows for very dense packing of observation channels 7a through 7d, making it possible to achieve an overall compact design for the stereomicroscope of the present invention.

After exiting zoom system 7, observation beams 20a through 20d are deflected by additional deflecting element 6a.

This deflecting element 6a directs observation beams 20a through 20d substantially into the vertical direction again. Subsequently, the observation beams strike an additional deflecting element 6b, where they are deflected into the horizontal direction again and, possibly after passing through further optical components denoted as a whole by 8, they impinge on deflecting element 9, the function of which will be explained below. At this point, it is noted that deflecting element 6a and/or deflecting element 6b may be in the form of optical beam splitters, making it possible to define observation axes denoted by 15 and 18; i.e., respective central axes for observation beams extending parallel thereto. In order to define observation axis 18, an additional deflecting element 6c is used, as shown in FIG. 1.

Observation axes 15, 18 may be used for 180-degree viewing by an assistant (using third and fourth observation beams 20a, 20b), the vertical distance between object 16 and observation axis 18 being greater than that between object 16 and observation axis 15.

As schematically shown in FIG. 1 at observation axis 15, third and fourth observation beams 20a, 20b are received by a (two-channel) stereo camera 40a. Thus, the stereo camera provides an image having a horizontal stereo basis, because the captured beams 20a, 20b extend at the same level or height through observation channels 7a, 7b. Stereo camera 40a has one imaging optical system 30 and one camera chip 35 for each of beams 20a, 20b. It is also conceivable to capture both beams via one camera chip. Using a suitable processing device or evaluation electronics (not shown), a stereoscopic image can be generated from the data captured by the two camera chips 35, and be transmitted, for example, to monitor 42a which allows object 16 to be viewed from a perspective corresponding to a 180-degree position.

As for additional observation axis 18, it can be seen that first and second observation beams 20c, 20d are directed to an additional stereo camera 40b. Thus, a stereoscopic image having a vertical stereo basis is provided this stereo camera 40b by means of suitable optical systems 30 and camera chips 35. In accordance with the present invention, this image is then fed to a monitor (display device) located in a 90-degree position (i.e., rotated 90 degrees about a vertical axis of rotation). This monitor is not shown in FIG. 1, but is located in front of microscope body 1; i.e., in front of the plane of the paper, according to the representation of FIG. 1. At the same time, the image is rotated 90 degrees with respect to a horizontal axis of rotation. This will be explained below in more detail with reference to FIG. 5. An observer located in the 90-degree position and using this monitor will see an image that is true to reality (with a horizontal stereo basis) while viewing from the 90-degree position.

It is noted that, alternatively, an image having a vertical stereo basis could be provided at observation axis 15, and an image having a horizontal stereo basis could be provided at observation axis 18.

In FIG. 5, microscope body 1 is shown along with stereo camera 40b in a view from above. The stereo camera has a processing device 41. Also shown here is the monitor, which is disposed in the 90-degree position and denoted by 42b. The other components of the microscope are not shown here for clarity of presentation.

In FIG. 5 can be seen the (schematically represented) observation beams 20c, 20d which, in this perspective, extend one above the other and which are the ones that pass through the two observation channels 7c, 7d defining the vertical stereo basis. A corresponding image is captured by stereo camera 40b.

At 42b, it can be seen that this image, which has a vertical stereo basis, is presented to the user at the 90-degree position in the form of an image or picture having a horizontal stereo basis (schematically indicated by two arrows).

Further essential observation axes for the main observer and assistant observer are designated 14 and 23 according to the embodiment shown, as will be explained in more detail below.

Beams 20a through 20d, which are deflected into the horizontal direction by deflecting element 6b, strike deflecting element 9, as mentioned earlier. Deflecting element 9 is configured to deflect only beams 20c, 20d, while beams 20a, 20b pass through deflecting element 9 without deflection and strike additional deflecting element 6d.

FIG. 3 shows deflecting element 9 in the direction of incidence of beams 20a through 20d. The cross sections of beams 20a through 20d strike corresponding regions 9a through 9d of the deflecting element. In order to deflect observation beams 20c, 20d, regions 9c, 9d of deflecting element 9 are made reflective, whereas regions 9a, 9b are transparent, so that observation beams 20a, 20b can pass therethrough unhindered.

By using a deflecting element 9 of this kind, main observations beams 20a, 20b can by spatially separated from the assistant's observation beams 20c, 20d in a constructionally simple way without loss of light intensity, which is unavoidable when using semi-transparent beam splitters, for example.

As already mentioned, main observation beams 20a, 20b, after passing through regions 9a, 9b of deflecting element 9, strike additional deflecting element 6d, by means of which the horizontally extending observation beams 20a, 20d are deflected vertically downwards, the observation beams 20a, 20b then striking another deflecting element 6e which causes another deflection into the horizontal direction, thereby defining the observation axis 14 mentioned above. Observation axis 14 is characterized by a particularly small vertical distance from object 16 to be observed.

If, however, a greater vertical distance from object 16 is desired, e.g. for ergonomic reasons, deflecting element 6d can be omitted, thus resulting in the observation axis designated 17. Alternatively, it is possible to make deflecting element 6d semi-transparent so that the two viewing positions 14 and 17 mentioned can be achieved at the same time.

Similarly to observation axes 15, 18, stereo cameras 40d, 40e may be provided for observation axes or positions 14 and/or 17. The optical components and camera chips for stereo cameras 40d, 40e are not shown in FIG. 1. By providing such stereo cameras 40d, 40e and associated display and/or viewing devices (not shown), a video representation of the operating field is also provided to a main observer or main operator.

It is noted that it is also conceivable that the main operator could observe the operating field or object without a stereocamera being interposed therebetween, while a video representation is provided to the assistant as described above. However, it is preferred to provide a video representation to both the main operator and the assistant.

Thus, by suitable design of deflecting element 6d, the main observer, for example, is able to look through a binocular tube (not shown) into the microscope either at the level of observation axis 14 or at the level of observation axis 17. In practice, this will depend on the ergonomically necessary or desirable overall height of the microscope. The same is true for the other observation axes 15, 18 mentioned above, which are variants to allow for co-observation by an assistant at a fixed 180-degree position.

Through a special design of deflecting elements 6c, 6d and 6e, axes 14, 17 and 18 may also differ from the right angle to axis 11 shown in FIG. 1, or may even be variable if said deflecting elements are capable of being tilted.

Because of the number of deflections, care must be taken to ensure that the design of deflecting elements 6c, 6d, 6e and 10 is such that there is always an upright, laterally correct image present at axes 14, 17, 18 and 23. This can be achieved, for example, by using roof edges and/or pentaprisms.

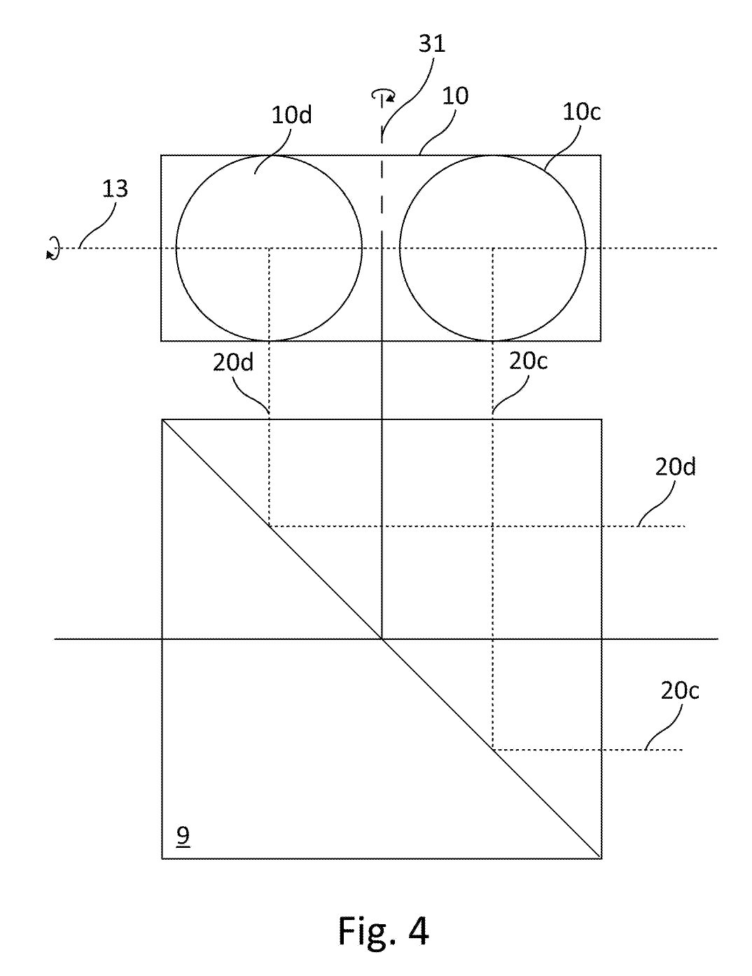

After deflection in the regions 9c, 9d of deflecting element 9, first and second observation beams 20c, 20d strike another deflecting element denoted by 10. This deflecting element 10 may consist of a number of deflecting components which are linked by what is known as a 2a gear mechanism so that observation beams 20c, 20d can be deflected out of the plane of the paper of FIG. 1 about a rotation axis 13. A 2α gear mechanism is understood to be a gear mechanism which converts an input-side rotation through an angle α into a rotation through an angle of 2α on the output side. This will be explained below in more detail with reference to FIG. 4.

FIG. 4 shows observation beams 20c, 20d deflected by deflecting element 9 into the vertical direction. In the view of FIG. 4, deflecting element 10 has two deflection regions 10c, 10d by which observation beams 20c, 20d can be deflected, for example, perpendicularly out of the plane of the paper. Pivoting deflecting element 10 about axis 13 makes it possible to move the assistant's viewer from the right hand to the left hand side of microscope about axis 13, i.e. over the upper surface of the microscope body 1. In prior art approaches, the assistant's viewer could only be rotated about vertical axis 11 or 31 around the front of a microscope, as a result of which obstacles could arise, for example, because of other optical components located in the area of the front of the microscope, resulting in the need for laborious adaptation to change the viewing position for the assistant.

Instead of deflecting element 10 shown, it is also possible to provide a mechanical interface which accommodates what is known as a 180-degree binocular tube, which, in principle, allows the same deflection, but whose overall length may have to be corrected. It is noted that a 180-degree binocular tube is a stereoscopic viewing device which includes eyepieces and is always arranged above the zoom system. The 180-degree binocular tube serves, in particular, to convert parallel beams into converging beams. It should also be possible to use a separate zoom system and, optionally, additional deflecting elements, inverting systems for image erection, beam inverters such as SDI-systems, filter inserts and/or imaging optical systems for ergonomically deflecting beams in the assistant's viewer. In the illustrated embodiment of the stereomicroscope of the present invention, it is also conceivable to make deflecting element 10 rotatable about axis 31, as known from the prior art, in addition or as an alternative to the above-described rotation about axis 13.

Deflecting element 10 may also be partially or semi-transparent, allowing beams 20c, 20d to strike an additional stereocamera 40c disposed on the top of microscope body 1. Stereocamera 40c has the same design as, for example, stereocamera 40b, and delivers a corresponding stereoscopic image which is based on first and second observation beams 20c, 20d and can be presented to an observer (via a suitable monitor) in a 90-degree position as a realistic image.

In this connection, it is noted that stereocamera 40c can also receive the aforementioned observation beams if deflecting element 10 is completely omitted. This would actually increase the light input into stereocamera 40c. Finally, it is noted that, using deflecting element 10, the stereoscopic image provided by observation beams 20c, 20d, which initially defines a vertical stereo basis, for example during passage through zoom system 7, can be viewed with a horizontal stereo basis. Thus, this effect corresponds to the above-described case where the image provided at observation axis 18; i.e., at the 180-degree position with a vertical stereo basis is presented in the 90-degree position with a horizontal stereo basis.

It is pointed out that the deflection described for all the deflecting elements shown is chosen to be substantially 90 degrees, purely by way of example. Depending on the amount of space available, larger or smaller deflection angles may be necessary or desirable. Since this can be implemented in all spatial directions, the resulting deflections may be skewed.

It is also possible to insert additional optical components in the optical paths described. Examples of such components are shown in FIG. 1 and denoted by 8a, b, c. Additional components 8 may be optionally inserted at the indicated positions. Such components may be used, for example, for intermediate imaging or pupil displacement. These elements may also be shutters which interrupt or enable the flow of light as desired in different possible combinations in the different observation channels. Mechanical shutters or displays having controllable electrochromic layers may be used for this purpose. By lining up components along a horizontal axis in this way, it is possible to effectively avoid non-ergonomic excessive overall height, as is found with conventional opthalmological stereoscopic assistant microscopes.

Zoom system 7 is conveniently characterized in that it allows magnification in the range from 5-10, each observation channel preferably consisting of at least three optical groups, of which at least one group is fixed. In addition, the observation channels should be aligned parallel to one another.

In the view of FIG. 1, main objective 2 is shown as being symmetrical to its axis 11. The main objective may also be arranged off-center with respect thereto. The optical correction of this objective is advantageously achromatic or apochromatic, taking special account of the secondary spectrum.

The beam cross sections (pupils) shown in FIGS. 2 and 3 may have different diameters and may be in any desired position relative to one another. The distances between the center points of beams 20a, 20b and 20c, 20d are typically referred to as stereo bases and have a value between 20 mm and 30 mm. If an obstacle occurs, for example deflecting element 9, which is intended to let some of the observation beams pass through unimpeded, further deflecting elements in the beam axes may give rise to the need for larger distances between the individual observation beams, which can be recombined and reduced after bypassing the obstacle.

With reference to FIG. 1, in particular, it is clear that beams 20a, 20b (on the vertical path) between object 16 and first deflecting element 5 have to cover the same distance as they impinge on the deflecting element 5 at the same height. In contrast, the distances to be covered accordingly by beams 20c, 20d between the object and the first deflecting element are different because of the different vertical heights of the points of impingement on deflecting element 5, so that further along the optical path through the microscope a corresponding compensation has to be provided. In accordance with the present invention, such compensation is provided by means of a corresponding number or alignment of additional deflecting elements, in the present instance 6a, 6b and 6c, so that when observation axis 23 is reached, the distances have been equalized accordingly.

### LIST OF REFERENCE NUMERALS

1 microscope body
2 main objective
3 illumination device
3a deflecting element
4 fiber cable
5 deflecting element
6a, 6b, 6c, 6d, 6e deflecting elements
7 zoom system
7a, 7b main observation channels
7c, 7d assistant's observation channels
8a, b, c optional additional components, such as filters, laser shutters, SDI, optical splitters, and data superimposition devices
9 deflecting element for the assistant's beam path
9a, 9b, 9c, 9d regions of passage or deflection of the deflecting element 9
10 deflecting element for pivoting the assistant's beam path
10c, 10d deflecting regions of deflecting element 10
11 axis of symmetry of the main objective
12 axis of the illumination device
13 rotation axis of deflecting element 10
14 observation axis
15 observation axis
16 object
17 observation axis
18 observation axis
20a, 20b main observation beams
20c, 20d assistant's observation beams
23 assistant's observation axis
27 central axis of zoom system
30 optical system
31 axis
35 camera chip
40a, 40b, 40c, 40d, 40e optoelectronic image-capturing device (stereo camera)
41 processing device
42a, 42b display device (monitor)

What is claimed is:

1. A video stereomicroscope comprising
a main objective having a substantially vertical optical axis;
a deflecting element provided downstream of the main objective to cause light passing through the main objective to be deflected into a substantially horizontal direction;
a zoom system disposed downstream of the deflecting element, the zoom system having at least two substantially horizontally extending observation channels, a first observation channel of the at least two observation channels and a second observation channel of the at least two observation channels being vertically spaced from each other; and
at least one optoelectronic image-capturing device provided downstream of the zoom system and arranged to provide a stereoscopic image based on beams of radiation passing through the first observation channel and the second observation channel.

2. The video stereomicroscope as recited in claim 1, wherein the stereoscopic image provided by image-capturing device has a vertical stereo basis, and the video stereomicroscope further comprises a display device arranged to display the stereoscopic image with a horizontal stereo basis.

3. The video stereomicroscope as recited in claim 2, wherein the display device is disposed in a viewing position offset 90 degrees from the image-capturing device.

4. The video stereomicroscope as recited in claim 1, wherein the optoelectronic image-capturing device is a two-channel stereo camera.

5. The video stereomicroscope as recited in claim 4, wherein the stereo camera has one imaging optical system and one camera chip for each observation channel.

6. The video stereomicroscope as recited in claim 4, wherein the stereo camera has one camera chip for two observation channels and electronics for processing an image provided by the one camera chip.

7. The video stereomicroscope as recited in claim 2, wherein the transmission of data between the image-capturing device and the display device is via cable.

8. The video stereomicroscope as recited in claim 2, wherein the transmission of data between the image-capturing device and the display device is wireless.

9. The video stereomicroscope as recited in claim 2, wherein the at least two substantially horizontally extending observation channels of the zoom system includes a third observation channel and a fourth observation channel, said third and fourth observation channels extending at substantially the same horizontal level.

10. The video stereomicroscope as recited in claim 9, wherein the video stereomicroscope has an additional image-capturing device for providing an additional stereoscopic image based on beams of radiation passing through the third and fourth observation channels, and an additional display device associated with said additional image-capturing device and arranged to display the additional stereoscopic image.

11. The video stereomicroscope as recited in claim 1, wherein the vertically spaced first and second observation channels are rotatable about a longitudinal central axis of the zoom system.

12. The video stereomicroscope as recited in claim 11, wherein the observation channels are automatically rotatable about the central axis of the zoom system.

13. A method for viewing a stereoscopic image using a video stereomicroscope including a main objective having a substantially vertical optical axis, a deflecting element provided downstream of the objective to cause light passing through the main objective to be deflected into a substantially horizontal direction, and further including a zoom system which is disposed downstream of the deflecting element and has at least two substantially horizontally extending observation channels, a first observation channel and a second observation channel of the zoom system being vertically spaced from each other,
wherein the method comprises the step of providing a stereoscopic image based on beams of radiation passing through the first observation channel and the second observation channel.

14. The method as recited in claim 13, further comprising the steps of positioning an image-capturing device to capture the stereoscopic image, and presenting the stereoscopic image for viewing via a display device at an offset from the position of the image-capturing device.

15. The method as recited in claim 14, wherein the offset is a rotation of 90 degrees from the image-capturing device and a rotation of 90 degrees about a horizontal axis of rotation.
